(19) United States
(12) Patent Application Publication
(10) Pub. No.: US 2009/0153291 A1
(43) Pub. Date: Jun. 18, 2009

(54) METHOD AND APPARATUS FOR COMMUNICATING ACCESS TO A LOCKBOX

(75) Inventors: Wayne F. Larson, Salem, OR (US); Teri Lynne Briskey, Monmouth, OR (US); Jeff Antrican, Salem, OR (US); Peter C. Myers, Beaverton, OR (US); Jonathan G. Hays, Newberg, OR (US)

Correspondence Address: KLARQUIST SPARKMAN, LLP, 121 S.W. SALMON STREET, SUITE 1600, PORTLAND, OR, 97204, US

(73) Assignee: GE Security, Inc.

(21) Appl. No.: 12/267,435

(22) Filed: Nov. 7, 2008

Related U.S. Application Data
(60) Provisional application No. 60/987,401, filed on Nov. 12, 2007.

(51) Int. Cl. G08B 29/00

(52) U.S. Cl. 340/5.33

(57) ABSTRACT

A real estate security system is described wherein access to a lockbox, that houses a key, causes automatic notification to an owner/occupant associated with the property. Such a communication can be used to alert the owner/occupant that a real estate showing is started or completed, that a friend or family member arrived home safely, that a property management accessed the house, or that emergency personnel accessed the house. The lockbox can include additional features that cause notification to the owner, such as automated sensing of tampering with the lockbox, or depressing a button on the lockbox to generate a signal to the owner/occupant of the property.

### CROSS REFERENCE TO RELATED APPLICATION

This application claims the benefit of U.S. Provisional Patent Application No. 60/987,401, filed Nov. 12, 2007, which is hereby incorporated by reference.

### FIELD

This application relates to real estate security and communications systems, and in particular to systems used to provide access to real estate properties without directly involving the principal owner or occupant, such as during real estate transactions.

### BACKGROUND OF THE INVENTION

Conventionally, systems used to provide access to real estate properties may include a lockbox that houses a key to a property. The key is secured against unauthorized access unless an authorized individual, such as a real estate agent with current rights, enters the correct combination on a mechanical lockbox or uses an electronic key to communicate the agent's credentials (such as one or more codes or identifiers) to an electronic lockbox.

Some conventional systems have centralized administration for managing the properties currently listed for sale, the credentials of agents, access restrictions, updates and other information. The electronic keys used by the agents are configured to communicate with the central administration periodically, which allows information about activity at specific properties and by specific agents to be collected for the central administration. In addition, the central administration can communicate messages to the agents and update their credentials.

Given the quickening pace of real estate decisions and consumer preferences today, there is a need to provide greater flexibility in the scheduling of real estate showings and enhanced information about showings (including feedback from buyer's agents and/or prospective buyers) delivered to sellers and/or listing agents more quickly.

For example, it would be advantageous to conduct real estate showings more efficiently. In a typical showing, the current owner or occupant of the property is requested to leave so that the prospective buyer and buyer's agent may tour the property freely and ask candid questions. Current owners are often asked to leave for the expected duration of the showing, which might even be a period of hours. If a prospective buyer decides quickly that she is uninterested, however, it can be difficult to arrange for communicating the new schedule to the temporarily displaced owner. In addition, it is difficult to collect feedback following showings and promptly distribute it to interested parties, particularly in cases where the listing agent is not present at the showing.

According to one conventional approach, a “beacon” is installed at the property, and it serves to communicate with an electronic pager carried by the temporarily displaced homeowner to indicate when a showing is complete and the owner can return to the property. Under the current approach, however, this beacon must be configured by connection over a phone line to a central server, and the central server is involved in all communications.

It would be advantageous to address the drawbacks in the conventional approaches.

### BRIEF SUMMARY OF THE INVENTION

A real estate security system is described wherein access to a lockbox, that houses a key, causes automatic notification to an owner/occupant associated with the property. Such a communication can be used to alert the owner/occupant that a real estate showing is started or completed, that a friend or family member arrived home safely, that a property management agent accessed the house, or that emergency personnel accessed the house. The lockbox can include additional features that cause notification to the owner, such as automated sensing when the lockbox is being tampered with, or automated notification in response to depressing a button on the lockbox.

### BRIEF DESCRIPTION OF THE DRAWINGS

The foregoing and other features and advantages will become more apparent from the following detailed description, which proceeds with reference to the accompanying figures.

FIG. 1 is schematic diagram showing the major components of the overall system and how they interact and communicate.

FIG. 2 is a schematic view of a lockbox showing a storage area suitable for holding one or more keys or other access aids.

FIG. 3 shows a more detailed front elevational view of an exemplary lockbox.

FIG. 4 is an embodiment of a hardware circuit that can be associated with the lockbox of FIG. 2.

FIG. 5 is a flowchart of a method for communicating access of the lockbox to a remote party.

FIG. 6 is a flowchart of a method for communicating access of the lockbox to a remote party using a remote server.

FIG. 7 is a flowchart of a method for automatic detection of key removal from a lockbox.

FIG. 8 is a system diagram showing interaction between an alarm system of the property and the lockbox.

### DETAILED DESCRIPTION OF THE INVENTION

Disclosed below are representative embodiments of a lockbox that should not be construed as limiting in any way. Instead, the present disclosure is directed toward all novel and nonobvious features and aspects of the various disclosed methods, apparatus, and equivalents thereof, alone and in various combinations and subcombinations with one another. The disclosed technology is not limited to any specific aspect or feature, or combination thereof, nor do the disclosed methods and apparatus require that any one or more specific advantages be present or problems be solved.

As used in this application and in the claims, the singular forms “a,”, “an” and “the” include the plural forms unless the context clearly dictates otherwise. Additionally, the term “includes” means “comprises.” Moreover, unless the context dictates otherwise, the term “coupled” means physically connected or electrically or electromagnetically connected or linked and includes both direct connections or direct links and indirect connections or indirect links through one or more intermediate elements.

Although the operations of some of the disclosed methods and apparatus are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods and apparatus can be used in conjunction with other methods and apparatus.

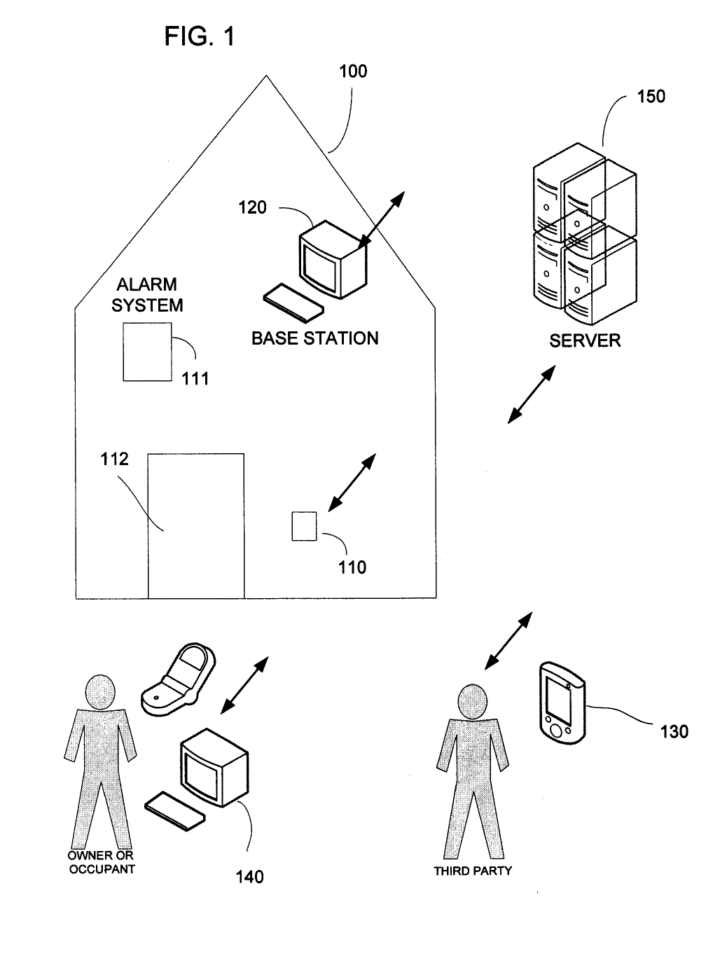

Referring to FIG. 1, there is a house 100 which is representative of any type of real estate property with which aspects of the system may be used. For the sake of the exemplary embodiments described below, the system is described in accordance with its use for the real estate market, and it is assumed that the house 100 is listed for sale.

The house 100 has been fitted with a lockbox 110. The lockbox 110 is generally secured outside a locked door 112 to the house. The lockbox 110 houses a key to the door 112 in a securable compartment accessible only if a correct combination is entered (for a mechanical lockbox) or if valid credentials are presented (for an electronic lockbox). Once accessed, such as by a real estate agent, the key in the lockbox can be used to open the door 112 of the house 100. Additionally, the lockbox 110 generally has a unique lockbox identifier associated therewith for identifying the lockbox 110.

In some embodiments, there can be a base station 120 associated with the house 100. The base station 120 would typically be located in the house 100. Additionally, in some embodiments, the house can include an alarm system 111 that can communicate directly with the lockbox or with the base station. As further described below, the alarm system 111 can be engaged and disengaged via access to the lockbox 110. The technical effect of such a disengagement of the alarm system is that the alarm system is automatically deactivated so that a third party can access the house without knowing the alarm system code.

A third party, such as a real-estate agent, friends or family members, or emergency response personnel (e.g., firemen or policemen) is represented by the figure shown at the lower right of the drawing. The third party represents any party seeking to make an authorized entry to a property. The current owner is represented by the figure at the lower left of the drawing, and is shown remote from the house 100, as would be the case if the owner was asked to leave the house to allow an agent to conduct a showing.

The third party is shown to have an electronic key 130. The electronic key 130 is used to provide credentials for accessing the lockbox 110. In addition, the electronic key may provide an interface to the system, and have mobile phone, smart phone and/or PDA capabilities. As already described, an electronic key 130 is not necessary in the case of a mechanical lockbox, which can use a combination or physical key to open.

Similarly, the owner is shown to have a device 140, which may be a mobile phone, smart phone, PDA, pager, computer or similar communications device.

At the upper right of the drawing, a remote server 150 is shown to represent the central administration of the real estate security and communication system.

As will be described below in connection with several embodiments, each of the various components of the system, if present, can communicate with at least one of the other components. The double-ended arrows in FIG. 1 are schematic representations of two-way communications for each of the component entities. Thus, as described for the various embodiments, the lockbox 110 can send to and/or receive communications from: the base station 120, the owner's device 140, the agent's electronic key 130 and/or the remote server 150.

For the various embodiments, the base station 120 can send and receive communications from: the lockbox 110, the owner's device 140, the agent's electronic key 130 and/or the remote server 150.

For the various embodiments, the server 150 can send and receive communications from: the lockbox 110, the base station 120, the owner's device 140 and/or the agent's electronic key 130.

For the various embodiments, the owner's device 140 can send and receive communications from: the lockbox 110, the base station 120, the agent's electronic key 130 and/or the remote server 150.

According to one embodiment, communication of showing information is enhanced by configuring the lockbox to be associated with the listing (i.e., a unique identification of the house or other property used in the real estate market) in the system's central administration, such as on the remote server 150. The lockbox 110 can be associated or assigned to the listing at the time it is installed at the house 100 or at another time, such as by using the system's website. In this way, if an optional base station 120 is added, configuration of the base station is easier because the lockbox 110 is already associated with the listing. In use of the optional base station, the lockbox can communicate activity such the initiation and/or completion times, or duration, of a showing to the base station 120. The base station 120 then communicates this information to the central administration via the remote server 150. The remote server 150 then communicates some or all of the showing information to interested parties. In addition, the system may include an optional base station 120 having a cellular modem or other communications circuit componentry allowing the base station 120 to dial phone numbers directly and without interacting with the remote server.

For example, if the information includes an indication that a showing of the property has ended, the owner receives an indication to this effect. Such an indication occurs when the lockbox 110 senses the key is present in the box after it had been removed. Optionally, the listing agent can also receive this indication to be alerted for activity concerning the listing. Also, the buyer's agent can receive a reminder so as to be prompted to give the prospective buyer's feedback on the listing. Alternatively, if friends or family of the owners arrive at the house, the owner can be alerted that they arrived safely at the house. This is particularly advantageous when parents can be alerted that their child arrived home safely.

Thus, the technical effect is that an owner or occupant of the property is automatically sent a communication when the lockbox is accessed.

The communication from the lockbox can include a lockbox identifier or other identifier allowing for identification of the lockbox with the administration's database. The communication from the lockbox 110 to the base station 120 can occur wirelessly, such as by radio communication or with a cellular modem. The communication from the base station 120 to the remote station 150 can occur via a wired connection (e.g., POTS dial up or direct, Internet, etc.) or wirelessly (cellular modem).

In some embodiments, the lockbox 110 also communicates the state of its battery life and/or its configuration to the base station.

Indications that a showing has ended may take many forms. The lockbox 110 can be configured to sense the return of the key to the storage compartment or to sense that the compartment has been returned to its locked state. The lockbox 110 may have a button, control or other input device which, when actuated, signals that a showing is complete. An input device on the lockbox is advantageous because it is familiar to agents and is often their last interaction with the property as they complete a showing.

In other embodiments, the electronic key 130 used by the agent sends notifications of the showing time(s) and/or duration. Again, the advantage is notifying the owner in real time so the owner can return (rather than waiting out a predicted 2-hour showing period when the prospective buyer missed the appointment or declined the property within the first 5 minutes). Also, the listing agent can be alerted so as to be available for communication with the prospective buyer and/or buyer's agent. Further, the listing agent can use the showing activity to gauge progress in selling the property, including whether a price change is warranted. Showing durations are also more accurately recorded.

Notifications from the agent's electronic key 130 can be configured to occur automatically (such as when a sensed event, like a lockbox interaction, occurs), or when prompted. For example, the electronic key 130 can be configured to issue visual or audio reminders to the agent after a showing is commenced, such as every 10 minutes or every 30 minutes, asking the agent if the showing is completed yet. Optionally, the electronic key 130 may provide for “snoozing” the reminders.

The owner's device 140 may be a pager, internet device, mobile phone, etc. that can receive a radio signal, call or message directly from the base station or from the lockbox. If the communication occurs from the base station 120 or lockbox 110 directly to the owner's device, then communication with the server 150 can be avoided, if desired.

One or more components can be provided with an interface to allow the owner to specify and revise times when the property cannot be available for showing. This eases the various relationships between owners, buyers and agents during busy times. This is especially true if the occupant is not the owner. The lockbox 110 and/or the base station 120 can be provided with an input device for specifying “do not show times.” Also, there may be a website utility available via the owner's computer 140 for specifying such times. Thus, this information is fed to the central administration and is available to agents via their communications with the administration, such as through periodic updates of the electronic keys via the remote server 150.

As indicated, the showing data is important to gauge prospective buyer interest, particularly for new listings. If a listing agent sees that each of the first five showings is concluded in less than 5 minutes, the agent might conclude that the property is priced too high. In addition, agents can use number and frequency of showings to compete for prospective clients. Also, showing information for a particular property can be compared with other similar properties, such as similarly priced properties or properties in the same location, to provide additional information to the agents, owners and prospective buyers.

The lockbox 110 can be configured to interface with any alarm system 111 at the property. First, the lockbox 110 can be configured to disarm the alarm system 111 when a showing is initiated and to rearm the alarm system 111 when a showing has ended. Also, the one or more of the base station functions may be integrated with the alarm console. Further, the alarms system's 111 connection to the alarm service provider may be integrated for use as a connection to the central administration. Similarly, the lockbox 110 can be configured to interface with any home automation system 111 present at the property. For example, the lockbox 110 can turn on lights when a showing is initiated and turn them off when the showing is concluded.

If the lockbox 110 is provided with an appropriate communications circuit, such as one including a cellular modem or other communications device, the lockbox can be configured to communicate with the server directly. In some embodiments, the base station 120 could then be eliminated. One potential advantage is that the server could direct communications to lockboxes 110 in the case of a stolen electronic key.

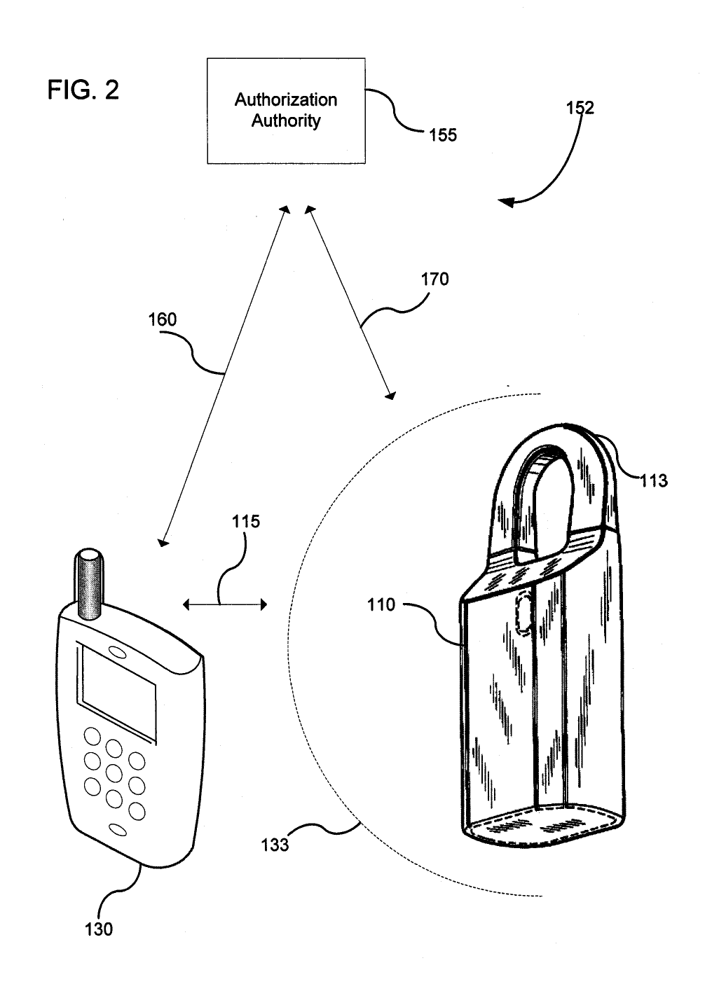

FIG. 2 is schematic view of a representative restricted range lockbox and access key system 152. An exemplary lockbox 110 with wireless communications capability is shown in relation to an access device, which in this example is a cellular telephone 130. The restricted range of the lockbox is shown schematically at 133. Thus, the cellular telephone as shown in FIG. 1 is outside of the lockbox's operating range 133, and would need to be moved within the range 133 to communicate with the lockbox 110. Other embodiments can be used where access can be accomplished even where the access device 130 is remote from the lockbox.

Communications between the lockbox 110 and the cellular telephone 130 may be two-way, as indicated by the two-way arrow representing a communications link 115. In some cases, one-way communication from the cellular telephone 130 to the lockbox 110 may be sufficient.

All of the conventional lockbox functions are supported. Thus, the communications from the cellular telephone 130 to the lockbox 110 would include the ability for the user of the cellular telephone 130 to make an access request directed to the lockbox 110. This access request would include communication of a credential indicating that the user is authorized for access.

In response, the lockbox may communicate a message, either via a display on the lockbox or via a message transmitted to the cellular telephone 130, denying access. Access may be denied, e.g., if the user is unauthorized, if the user's credentials have expired, or if the access privileges have been superseded (i.e., if the property owner has overridden access privileges or is invoking the call before showing feature).

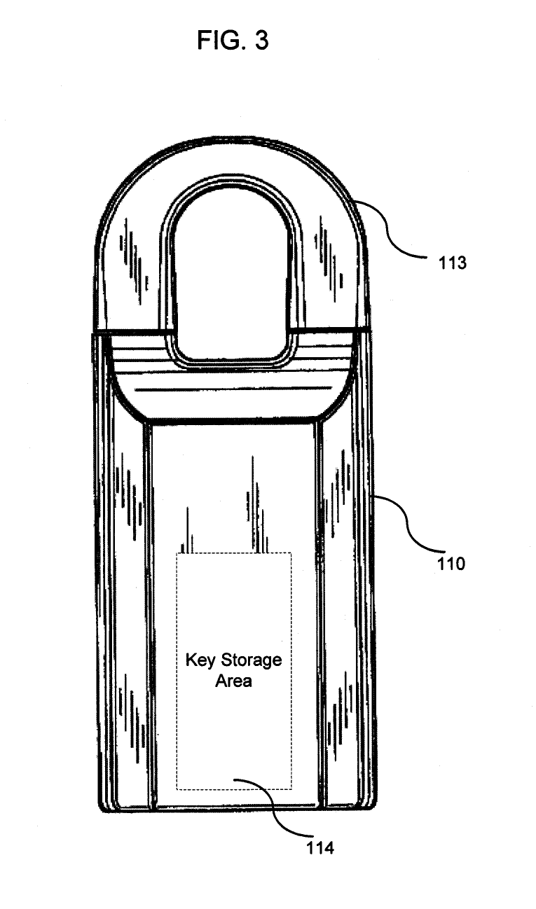

If access is granted, the lockbox 110 allows the user to gain access to a key storage area 112 (FIG. 3) in the lockbox 110 or open a shackle 113 for removing the lockbox from an object to which it is attached (e.g., a door). In specific implementations, the lockbox has a circuit that controls a lock mechanism that secures the key storage area and shackle in a locked condition when in use. When an access request is granted, the circuit unlocks the lock mechanism to provide the user access to the storage area 112, the shackle, or both.

The lockbox 110 may be a conventional lockbox using infrared communications capability. Alternatively, the lockbox can use near field or cellular communications. For example, the lockbox may be a conventional lockbox, such as the GE Security iBox® 1692, modified to use restricted range wireless communications, either instead of or in addition to the current infrared communications capability. The lockbox 110 may be further modified to function with power received from the access device, instead of from a dedicated battery in the lockbox 110. The cellular telephone 130 may be any cellular telephone having restricted range wireless communications capability or other equivalent access device.

Optionally, the system 152 may also include an authorization authority 155, which can be linked to the lockbox 110 (via a link 170), or to the cellular telephone 130 (via the link 160) or to both the lockbox 110 and the cellular telephone 130. The authorization authority can administer granting credentials to users, collect information on usage and activity and provide for updates to devices (lockboxes and access devices) in the system 152. The authorization authority can be positioned within the lockbox or external thereto.

FIG. 3 shows the lockbox 110 in more detail. If access is granted to the lockbox 110, the user can gain access to a key storage area 114 in the lockbox 110 or open a shackle 113 for removing the lockbox from an object to which it is attached (e.g., a door). In specific implementations, the lockbox has a circuit that controls a lock mechanism that secures the key storage area and shackle in a locked condition when in use. When an access request is granted, the circuit unlocks the lock mechanism to provide the user access to the storage area 112, the shackle, or both. Access to the storage area 114 can be further obtained through the use of a combination entered through a keypad (not shown).

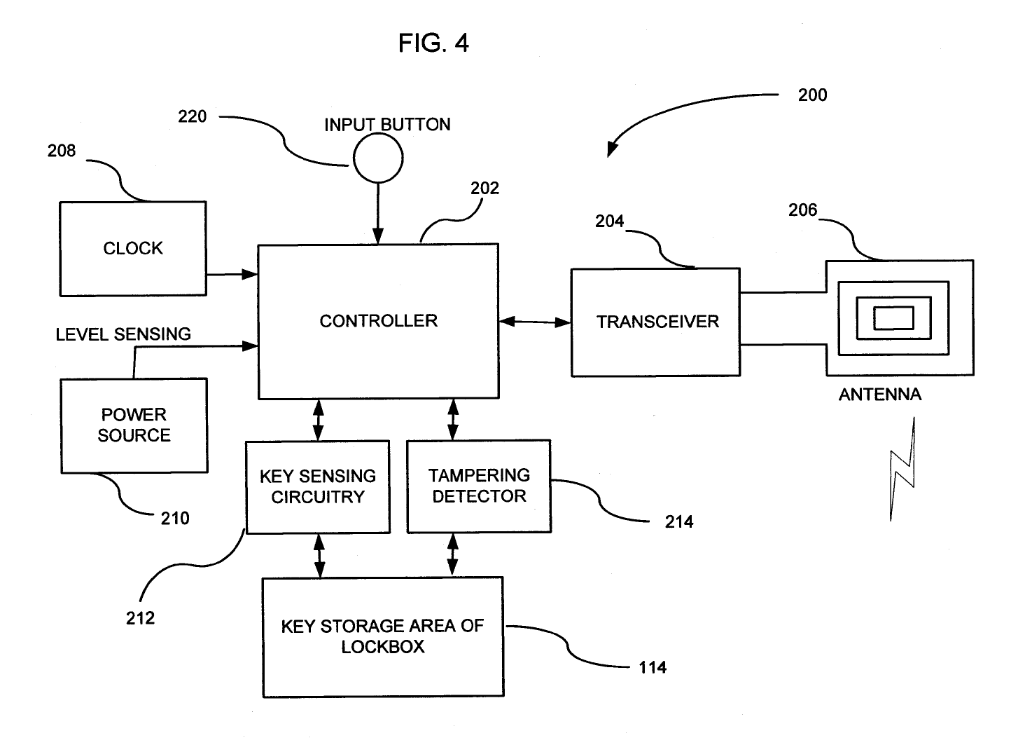

FIG. 4 shows an electronic circuit that can be housed in the lockbox 110. The circuit 200 can include a controller 202, such as a microcontroller or microprocessor. The controller has a storage area (not shown) that can store a unique lockbox identifier associated with the lockbox. The controller can be coupled to a transceiver 204, which allows communication between the controller and an antenna 206. The antenna 206 allows wireless communication with base station 120. The controller 202 can be further coupled to a clock 208 to provide a clock signal to the controller, as is well understood in the art. A power source 210 is coupled to all of the necessary components in the circuit 200 that require power, although the connections are not explicitly shown. The power source 210 can also be coupled to an input port of the controller for detecting a level of the power source. Such a connection allows the controller to report to an owner or occupant that the power source is low in energy and needing to be replaced. A key-sensing circuit 212 can be coupled between the key storage area 114 of the lockbox and the controller 202. The key sensing circuit 212 can detect when the key is present or absent from the key storage area 114. For example, the key may be attached to a removable token that slides into a receptacle area in the key storage area of the lockbox 114. When the token is inserted into the receptacle, the key-sensing circuitry 212 detects the presence of the token. When the key is removed from the key storage area 114, the token is removed from the receptacle and is likewise sensed by the key-sensing circuitry 212. Removal of the key can be reported to the controller, which can then take appropriate action, as further described below. The technical effect of such automated key-sensing circuitry 212 is that the lockbox can automatically report via the transceiver 204 that the key was removed or replaced. A tampering detector 214 can be coupled between the controller 202 and the key storage area 114 of the lockbox 110. The tampering detector 214 can sense forced entry to the key storage area 114, as is well understood in the art. One example of such a detection mechanism is to include in the tampering detector an accelerometer that can determine when unusual movement of the lockbox 110 is occurring, such as when the lockbox is being struck repeatedly. The technical effect of using the tampering detector 214 is that any unauthorized tampering with the lockbox can automatically be communicated via transceiver 204 to a third party. An input button or control 220 can also be coupled to the controller and can allow a user of the lockbox to provide further information to the controller 202. For example, when a real estate agent has completed showing a house, such a person may press the input button 220 to advise the controller that the showing is complete and that the owner or occupant needs to be notified accordingly. The technical effect of the button or control 220 is to allow someone accessing the lockbox 110 to immediately communicate with a third party information relating to the lockbox. The controller may also store information indicating when operation of the lockbox is prohibited and showings of the real estate are prohibited. At such times, the controller simply denies activating circuitry to open the lockbox or remove the shackle.

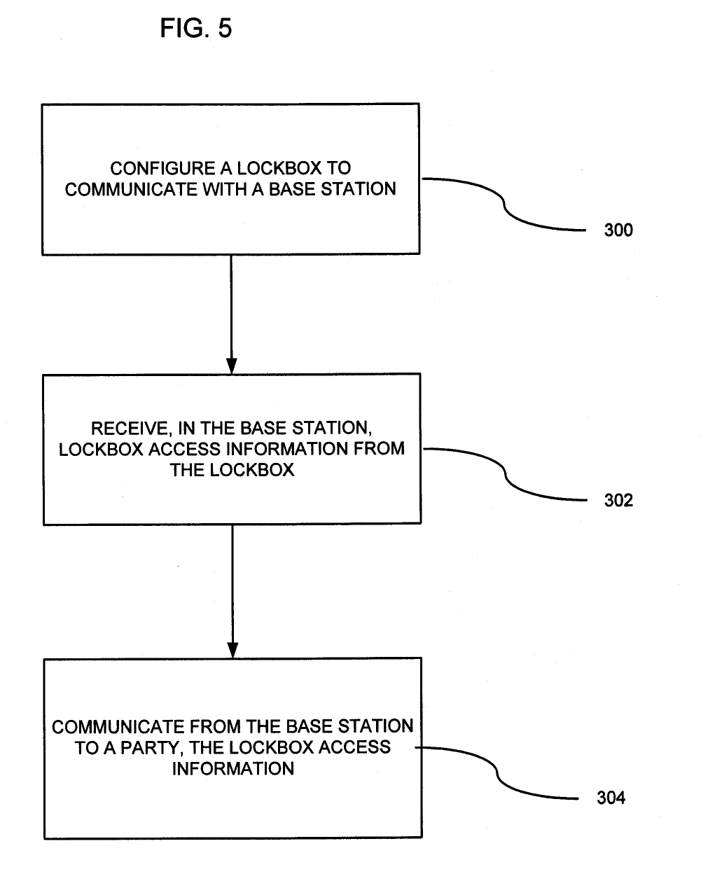

FIG. 5 shows a flow chart of a method for communicating between the lockbox and an owner or occupant of the property. This flowchart and others herein can be executed in software running on the controller, base station, and or server. In process block 300, the lockbox is configured to communicate with a base station at the property. Such a communication can occur using a wireless communication device, such as the antenna 206 of FIG. 4. In process block 302, the base station receives lockbox access information from the lockbox. The lockbox access information can include information indicating that the key was returned or removed from the lockbox, a time that the key was accessed, and/or an identification of the lockbox, and any other desired information. In process block 304, the base station can report the lockbox access information to a party, such as the owner of the property. Such communication can happen directly from the base station to the party or can occur through a remote server. In any event, the base station can communicate to the party using a cellular phone with an automated message or an email, a text message, etc. Again, the technical effect is automatic communication to a party regarding access to the lockbox.

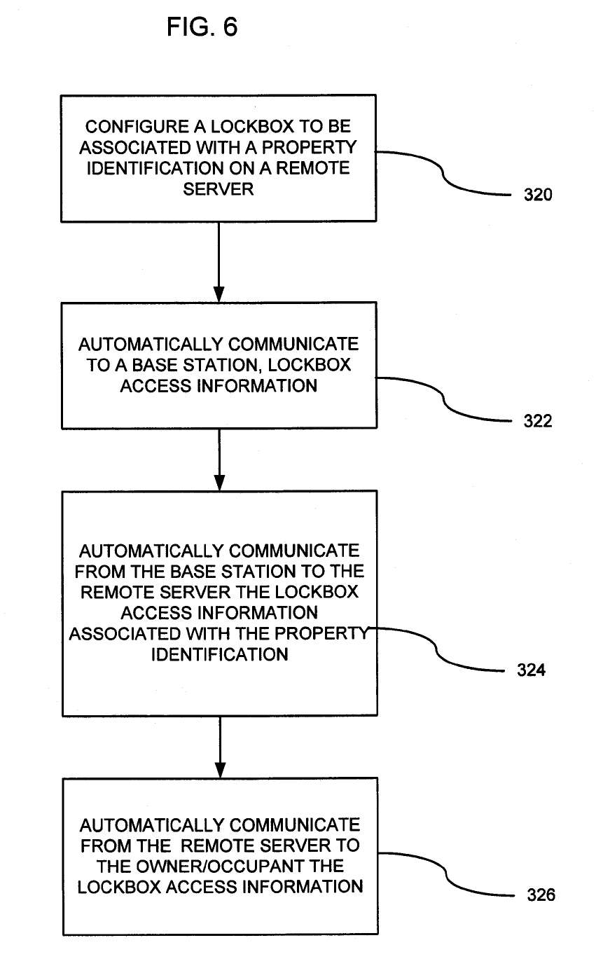

FIG. 6 shows a flow chart of a method for communicating lockbox access information to an owner or occupant. In process 320, the lockbox is configured to be associated with a property identification on a remote server. In process block 322, the lockbox can communicate the lockbox access information directly to the base station. Included in this communication can be a unique lockbox identifier associated with the lockbox. In process block 324, the base station can communicate the lockbox access information to a remote server together with the property identification. The remote server can associate the property identification of the lockbox with the access information. The server can also use the property identification to search a database in order to access records associated with the property identification. For example, the record may include the preferred mode for contacting the owner or occupant and the associated contact information. In process block 326, the remote server uses the information obtained from the database and automatically communicates the lockbox access information to the owner or occupant. Such communication may occur using cellular telephones with automated messages, emails, text messages, etc.

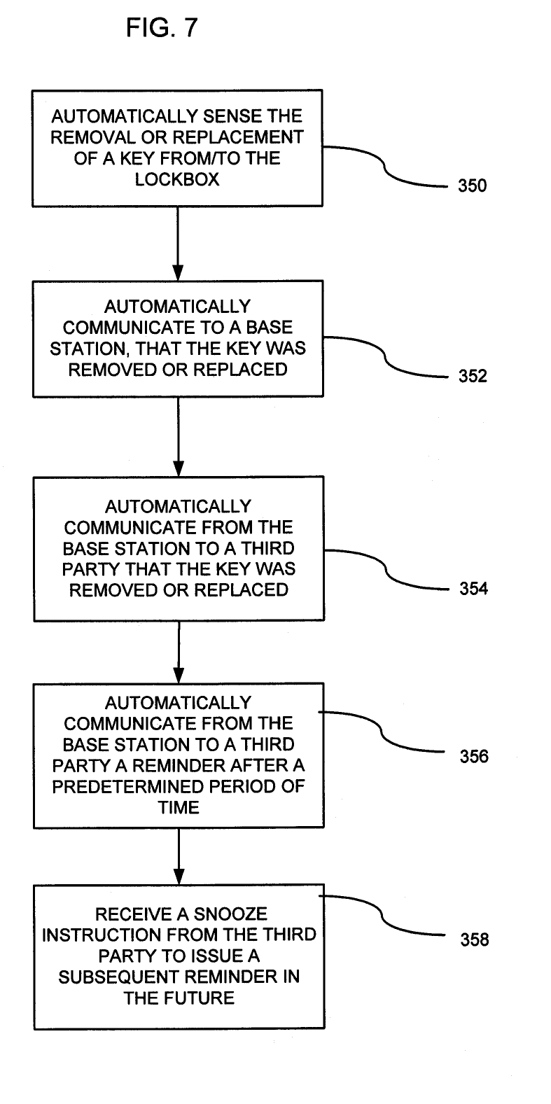

FIG. 7 is a flow chart of a method showing automated detection of key removal or replacement. In process block 350, the lockbox can automatically sense the removal or replacement of a key from or to the lockbox. As described above, such detection can occur using a token that fits into the lockbox. Alternative methods include a weight sensor that detects that the weight of the key is present on a hook mechanism. Other key detection mechanisms can be used. In process block 352, the lockbox can automatically communicate to a base station that the key was removed or replaced. As already described, this communication can occur using wireless communication or through a direct connection between the lockbox and the base station. In process block 354, the base station 120 can automatically communicate to a third party that the key was removed or replaced. Such communication may occur via a remote server or directly from the base station to the third party. In process block 356, after the key was removed, the base station can optionally communicate, to a third party, a reminder after a predetermined period of time. The reminder can optionally be generated by the electronic key 130 or the remote server 150.

Process block 358 shows another optional feature that the base station, electronic key or remote server may receive a snooze instruction from the third party that indicates to issue another reminder in the future.

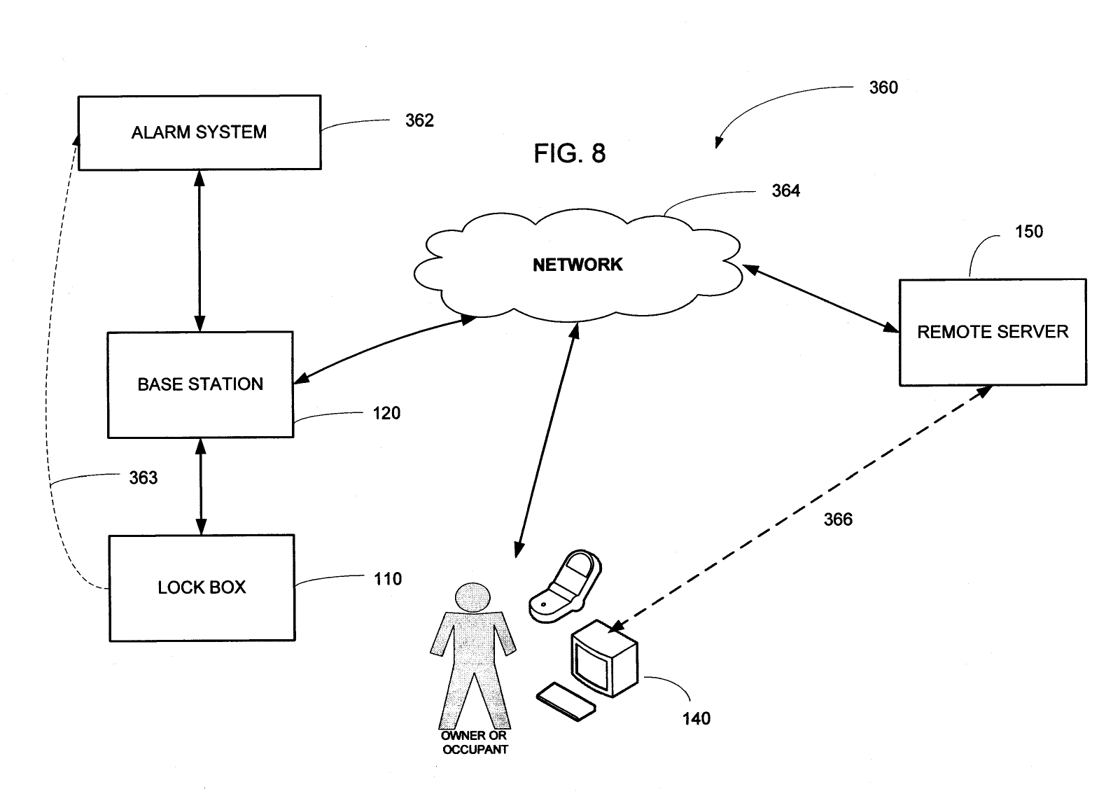

FIG. 8 is a system diagram 360 showing how the lockbox can be used in conjunction with an alarm system 362. The system 360 allows communication via a network 364, such as the Internet. The alarm system 362 is used to secure the property such that unauthorized access to the property alerts the proper authorities. The lockbox 110 can communicate to the base station 120 that the key to the property was accessed using proper credentials. In such a case, the base station automatically disengages the alarm system 362 so that the person that properly accessed the lockbox may enter the property. Simultaneously or nearly simultaneously, the base station can communicate via the network to the owner or occupant that the lockbox was accessed and that the alarm system 362 was turned off. Such communication may occur directly through the network 364 to the owner or occupant 140, or via a remote server 150 as indicated by the dashed line 366. When the party exits the house and the key is returned to the lockbox 11 0, such action can be detected by the lockbox and communicated to the base station that can re-engage or turn on the alarm system 362. A simple example can be that the party that enters the house may depress the button 220, which is an instruction to notify the owner or occupant 140 that a certain event has occurred and that the alarm system can be activated. Alternatively, the lockbox 110 can communicate directly with the alarm system 362 as shown by arrow 363.

In view of the many possible embodiments to which the principles of the disclosed invention may be applied, it should be recognized that the illustrated embodiments are only examples of the invention and should not be taken as limiting the scope of the invention. Rather, the scope of the invention is defined by the following claims. We therefore claim as our invention all that comes within the scope of these claims.

1. A security and communications system, comprising:
a lockbox positionable at a property to provide secured storage for a key to the property, the lockbox having a unique lockbox identifier; and
a base station positionable at the property to receive communications from the lockbox, the base station being configured to send communications to a remote server;
wherein the lockbox is programmed to communicate with the base station after an occurrence of a predetermined event and the remote server is programmed to communicate the predetermined event to a party associated with the property.

2. The system of claim 1, wherein the lockbox communicates the unique lockbox identifier to the base station.

3. The system of claim 1, wherein the lockbox communicates with the base station when a showing is concluded, and the base station in turn communicates to the remote server.

4. The system of claim 1, wherein the lockbox communicates with the base station when the key to property is removed from or returned to the lockbox.

5. The system of claim 1, wherein the lockbox comprises a wireless transceiver, a battery and a button actuatable by a user to indicate that the key is returned to the lockbox.

6. The system of claim 5, wherein the button can be depressed to indicate that the key is returned to the lockbox.

7. The system of claim 1, further including an alarm system coupled to the property that is automatically disengaged in response to a communication from the lock box or the base station.

8. The system of claim 1, wherein the lockbox includes a tampering detector to detect when unauthorized access to the lockbox has occurred.

9. The system of claim 1, wherein the lockbox comprises information specifying times when operation of the lockbox is prohibited and showings of the real estate property are prohibited.

10. The system of claim 1, wherein the base station is located at the property and comprises a communications circuit that establishes communication with a lockbox associated with the property, the base station further comprising an input device by which users may specify times when operation of the lockbox is prohibited and showings of the real estate property are prohibited.

11. A real estate security and communications system, comprising:
a lockbox positionable at a property having a secured storage area capable of holding a key to the property;
an electronic key configured to open the lockbox and access the secured storage area; and
a base station positionable at the property to receive communications from the lockbox or the electronic key in order to determine when the secured storage area of the lockbox has been accessed and to communicate the access of the lockbox to a party associated with the property.

12. The real estate security and communications system of claim 11, further including a remote server coupled with the base station.

13. The real estate security and communications system of claim 11, wherein the lockbox includes a transceiver for communication with the base station.

14. The real estate security and communications system of claim 11, further including a sensor in the lockbox for detecting if the key is present in the secured storage area.

15. A method for communicating to a party associated with the property that a lockbox located at a property has been accessed, comprising:
detecting access to a lockbox storage area capable of holding a key to the property;
communicating the detected access to a base station located at the property; and
communicating from the base station to a party associated with the property that the lockbox storage area has been accessed.

16. The method of claim 15, wherein the communication to the party occurs via an electronic key or a base station positioned within the property.

17. The method of claim 15, wherein communicating to the party includes informing the party if the key was taken or returned to the key storage area.

18. The method of claim 16, further including automatically detecting a level of a battery in the lockbox and transmitting the level to the base station.

19. The method of claim 15, wherein detecting further includes automatically detecting the presence of the key in the storage area of the lockbox.

20. The method of claim 15, further including automatically communicating a reminder after a predetermined time interval has elapsed since the detected access to the lockbox storage area.

21. The method of claim 15, wherein the communication to the party includes at least one of the following: an email, a text message to a mobile phone, and an automated phone call.

22. The method of claim 16, wherein communicating to the party from the base station occurs via a remote server.

23. The method of claim 15, further including automatically disengaging an alarm system associated with the property.

24. The method of claim 15, further including automatically detecting tampering with the lockbox and communicating to the party that such tampering occurred.

25. The method of claim 15, further including automatically sending the party a reminder that the agent has initiated a showing of a real estate property.

26. The method of claim 25, wherein the reminder is generated by an electronic key, a base station or a remote server.

27. The method of claim 25, wherein the reminder is a visual reminder or an audio reminder.

28. The method of claim 27, wherein the reminder is communicated automatically after a predetermined time interval has elapsed since the showing has been initiated.

29. The method of claim 25, wherein the reminder is communicated to at least one of an electronic key, a mobile telephone and computer assigned to a real estate agent.

30. The method of claim 25, further including receiving snooze instructions and issuing a subsequent reminder at a future time.
